(19) United States
(12) Patent Application Publication
(10) Pub. No.: US 2020/0132181 A1
(43) Pub. Date: Apr. 30, 2020

(54) ELECTROMAGNETIC CONTINUOUSLY VARIABLE TRANSMISSION SYSTEM

(71) Applicant: SOUTHERN TAIWAN UNIVERSITY OF SCIENCE AND TECHNOLOGY, Tainan City (TW)

(72) Inventors: Cho-Yu Lee, Tainan City (TW); Jui-Hung Chang, Tainan City (TW); Chin-Fong Lim, Melaka (MY)

(21) Appl. No.: 16/170,594

(22) Filed: Oct. 25, 2018

(51) Int. Cl. F16H 55/56; F16H 9/18; F16H 63/06; H01F 7/08; H01F 7/16

(52) U.S. Cl. CPC F16H 55/56; F16H 9/18; H01F 2007/086; H01F 7/081; H01F 7/1638; F16H 63/062

(57) ABSTRACT

An electromagnetic continuously variable transmission system is provided, including: a pulley, including a first disc having an axial sleeve and a second disc, the first disc having a plurality of grooves which extend radially at one side, pulley balls being slidably received within respective ones of the grooves, the first disc having a first slope at another side, the second disc being located by the side of the first disc with the grooves; a driving shaft, disposed in the axial sleeve and the second disc, the first disc being axially slidable relative to the driving shaft; an electromagnetic assembly, disposed on the pulley, including electromagnets spacingly arranged in a part of the grooves; when each of the electromagnets is electrified and generate magnetism, each of the electromagnets magnetically attracts one of the pulley balls toward the axial sleeve.

### BACKGROUND OF THE INVENTION

### Field of the Invention

The present invention relates to an electromagnetic continuously variable transmission system.

### Description of the Prior Art

Regarding a continuously variable transmission system used by a common motorcycle, as a revolution speed of an engine increases, the pulley balls in a pulley is driven by a centrifugal force and slide radially within a groove toward outside, the pulley is pushed and moves with a driving shaft toward a belt to push the belt, the belt moves toward an outer edge of a disc to change routing diameters between the belt and the pulley and between the belt and a rear wheel driving disc so as to shift speed in replacement of the transmission effect created by gear ratio. Therefore, in the conventional CVT, the speed shifting time and traits are determined by the weight of the pulley balls. When the pulley balls are heavier, the centrifugal force is greater, and the engine runs in a slow revolution speed and saves oil with less preferable acceleration capability; when the pulley balls are lighter, the centrifugal force is smaller, and the engine runs in a high revolution speed and has better acceleration capability. However, in recent years, most of the vehicles sacrifice their acceleration capability to saves oil, and the consumers using the motorcycles with CVT are unable to strike a balance between acceleration capability and oil-saving effect.

The present invention has arisen to mitigate and/or obviate the afore-described disadvantages.

### SUMMARY OF THE INVENTION

The major object of the present invention is to provide an electromagnetic continuously variable transmission system, in which a plurality of electromagnets are assembled in a pulley to magnetically attract a part of a plurality of pulley balls to be near one of two ends of a plurality of grooves near an axis so as to accelerate. When the plurality of electromagnets do not magnetically attract the plurality of pulley balls, the plurality of pulley balls can be moved to the other of the two ends of the plurality of grooves remote from the axis to save oil. Therefore, the electromagnetic continuously variable transmission system can provide preferable acceleration capability and oil-saving effect.

To achieve the above and other objects, an electromagnetic continuously variable transmission system is provided, including a pulley, a driving shaft and an electromagnetic assembly. The pulley includes a first disc and a second disc, a center of the first disc has an axial sleeve, one of two sides of the first disc on an axial direction has a plurality of grooves which extend radially, a plurality of pulley balls are respectively slidably received within respective ones of the plurality of grooves, the other of the two sides of the first disc has a first slope, and the second disc is located by the side of the first disc having the plurality of grooves. The driving shaft is disposed within the axial sleeve of the first disc and the second disc, and the first disc is slidable relative to an axial direction of the driving shaft. The electromagnetic assembly is disposed on the pulley and includes a plurality of electromagnets, and the plurality of electromagnets are spacingly arranged in a part of the plurality of grooves and near one end of the axial sleeve. When each of the plurality of electromagnets is electrified and produce magnetism, each of the plurality of electromagnets magnetically attracts one of the plurality of pulley balls corresponding thereto toward the axial sleeve.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a partially breakdown view of the preferred embodiment of the present invention;

FIG. 3 is a breakdown view of the preferred embodiment of the present invention;

FIG. 4 is another breakdown view of the preferred embodiment of the present invention;

FIGS. 5 and 6 are cross-sectional side views of the preferred embodiment of the present invention;

FIG. 7 is a top view of the preferred embodiment of the present invention;

FIG. 8 is a block diagram of the preferred embodiment of the present invention; and

FIG. 9 is a cross-sectional side view of another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

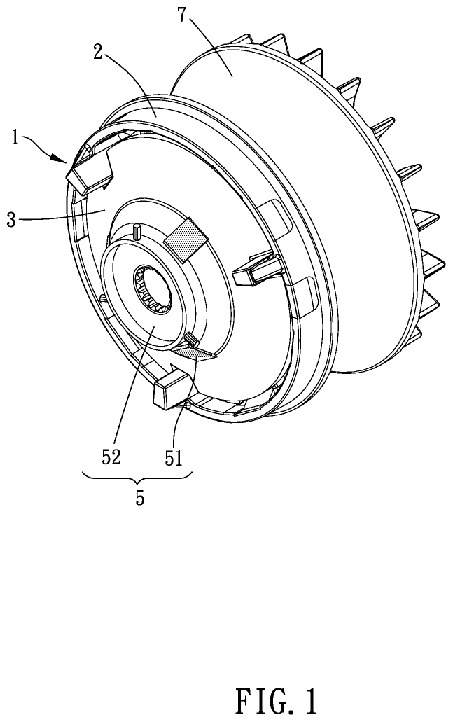

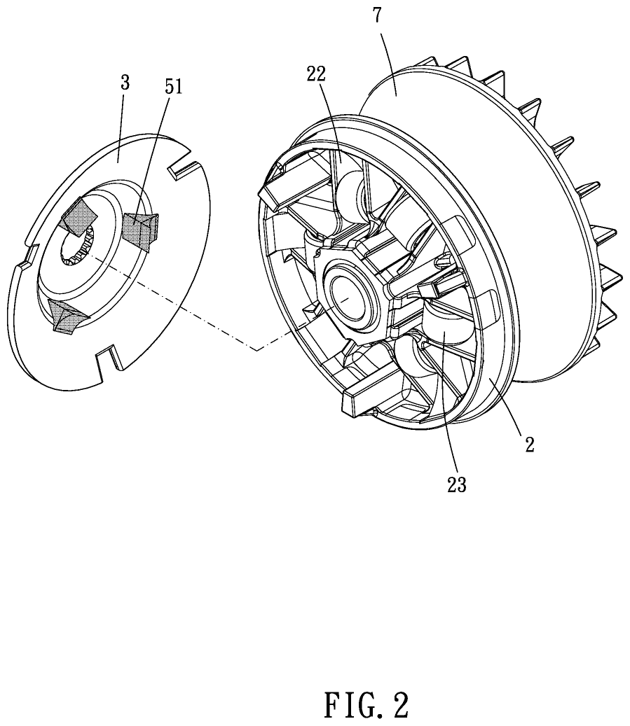

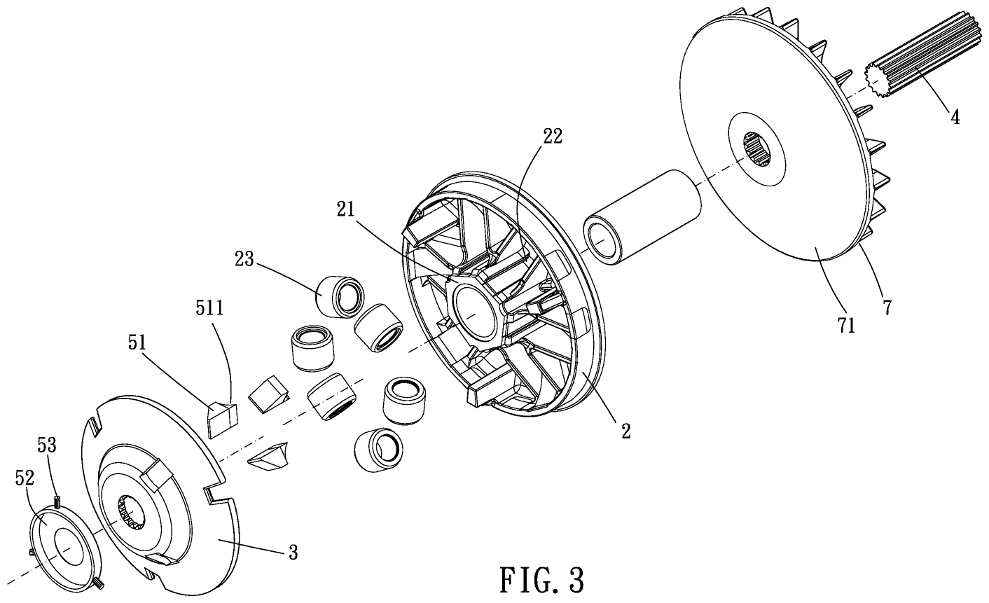

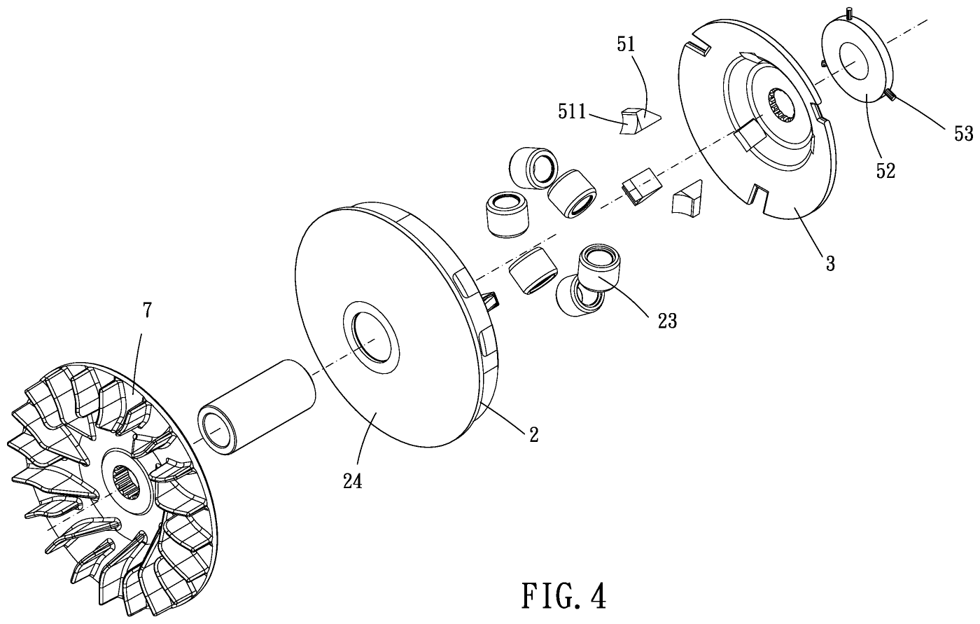

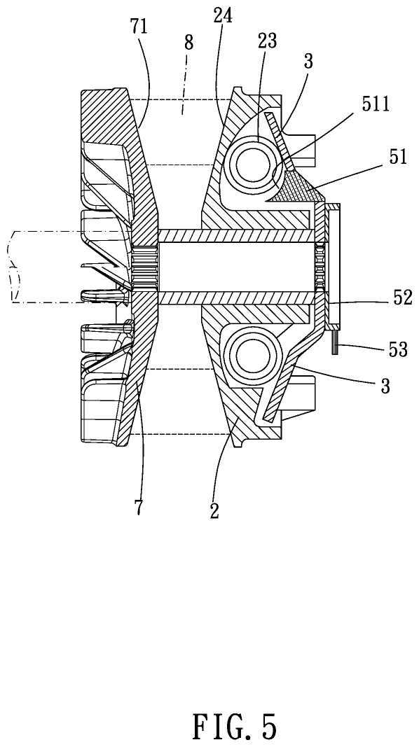

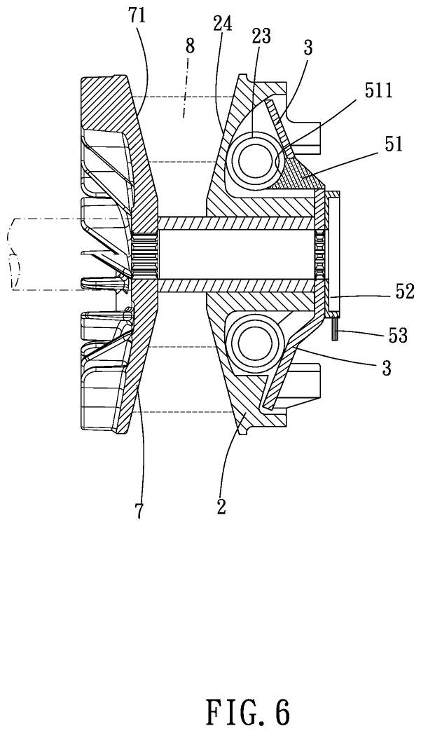

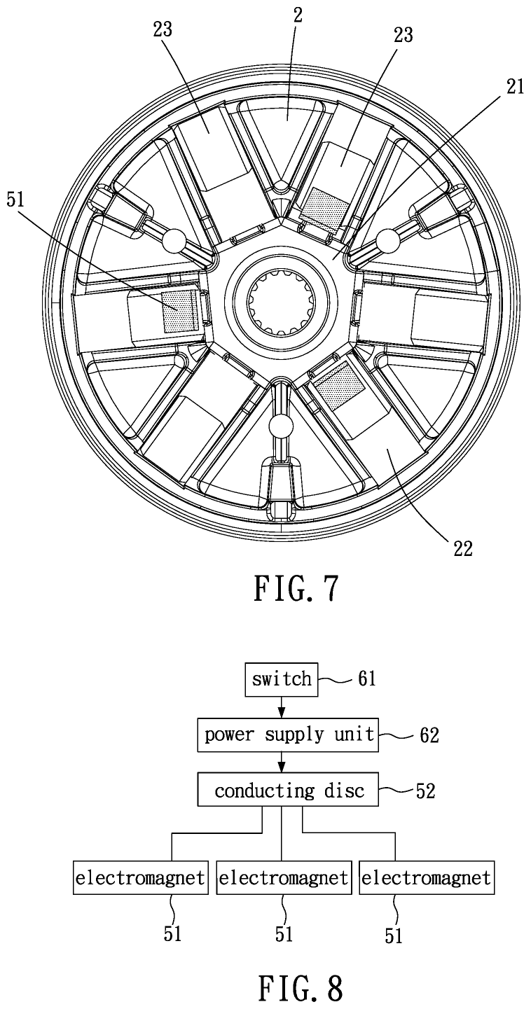

Please refer to FIGS. 1 to 8 for a preferred embodiment of the present invention. An electromagnet continuously variable transmission system includes a pulley 1, a driving shaft 4 and an electromagnetic assembly 5.

The pulley 1 includes a first disc 2 and a second disc 3, a center of the first disc 2 has an axial sleeve 21, one of two sides of the first disc 2 on an axial direction has a plurality of grooves 22 which extend radially, a plurality of pulley balls 23 are respectively slidably received within respective ones of the plurality of grooves 22, the other of the two sides of the first disc 2 has a first slope 24, and the second disc 3 is located by the side of the first disc 2 having the plurality of grooves 22.

The driving shaft 4 is disposed within the axial sleeve 21 of the first disc 2 and the second disc 3, and the first disc 2 is slidable relative to an axial direction of the driving shaft 4. In this embodiment, a third disc 7 is further provided, the driving shaft 4 is disposed into the third disc 7, the first disc 2 is between the second disc 3 and the third disc 7, one side of the third disc 7 toward the first slope 24 has a second slope 71, the first slope 24 and the second slope 71 are configured for engagement of a transmission belt 8 therebetween, through the first disc 2 moving toward or away from the third disc 7, the transmission belt 8 is pushed or released so that the transmission belt 8 moves radially outward or inward on the first slope 24 and the second slope 71 to shift speed.

The electromagnetic assembly 5 is disposed on the pulley 1 and includes a plurality of electromagnets 51, and the plurality of electromagnets 51 are spacingly arranged in a part of the plurality of grooves 22 and near one end of the axial sleeve 21.

Preferably, a number of the plurality of electromagnets 51 is half a number of the plurality of grooves 22. For example, in this embodiment, there are six grooves 22 and six pulley balls 23, and there are three electromagnets 51 spacingly arranged. In actual practice, when each of the three electromagnets 51 are electrified and generate magnetism, each of the three electromagnets 51 magnetically attracts one of the plurality of pulley balls 23 corresponding thereto toward the axial sleeve 21 so that the six pulley balls 23 will not moves radially outward due to a centrifugal force from a revolution of the pulley 1. At this moment, a part of the six pulley balls 23 in the first disc 2 which are not magnetically attracted by the three electromagnets 51 are still driven by the centrifugal force to move radially outward to shift speed, and since a part of the six pulley balls 23 will not move outward due to the centrifugal force during revolution, the pulley 1 has a lower moment of inertia, and an engine revolves in a higher speed and has a more preferable acceleration capability. On the contrary, if the three electromagnets 51 are not electrified, the six pulley balls 23 are not magnetically attracted by the three electromagnets 51 and can moves outward due to the centrifugal force, the pulley 1 has a higher moment of inertia, the engine revolves in a lower speed and can save oil. Therefore, a user can decide whether to electrify the electromagnets 51 to enhance acceleration capability or not to electrify the electromagnets 51 to save oil in accordance to his/her needs.

Specifically, the electromagnetic assembly 5 further includes a conducting disc 52, the conducting disc 52 is electrically connected to the three electromagnets 51, and the conducting disc 52 is disposed on one side of the second disc 3 remote from the first disc 2. In this embodiment, a control module 6 is further provided, the control module 6 includes a switch 61 and a power supply unit 62, and when the switch 61 is turned on, the power supply unit 62 supplies electricity to the conducting disc 52 to make the three electromagnets 51 to generate magnetism; on the contrary, when the switch 61 is turned off, the power supply unit 62 stop supplying electricity to the conducting disc 52 to stop the three electromagnets 51 from generating magnetism.

Preferably, a plurality of conductive brushes 53 extends radially beyond the conducting disc 52 so that when the conducting disc 52 revolve with the second disc 3, currents can be effectively transmitted to the conducting disc 52.

Furthermore, the three electromagnets 51 are disposed through the second disc 3 and project into the six grooves 22, in this embodiment, each of the three of electromagnets 51 has a curved surface 511 shaped in complementary to a circumference of one of the six pulley balls 23 so that the six pulley balls can tightly fit to the curved surface 511 of the three electromagnets 51 to prevent the six pulley balls 23 from shaking and enable the pulley 1 to revolve more stably.

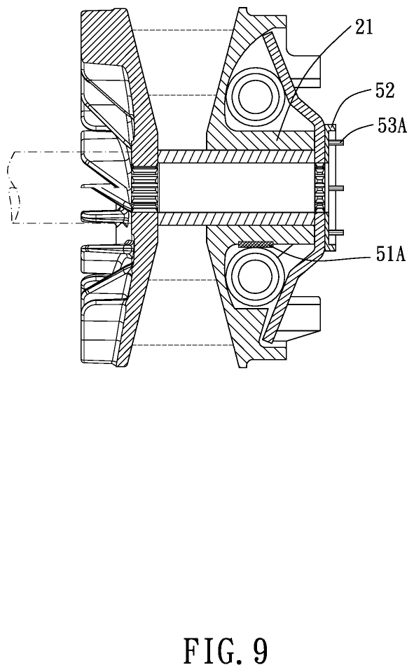

Compared to the embodiment above, in another embodiment shown in FIG. 9, a plurality of conductive brushes 53A extends radially beyond the conducting disc 52, and the plurality of conductive brushes 53A can effectively transmit currents to the conducting disc 52. A plurality of electromagnets 51A are disposed on an outer circumference of the axial sleeve 21, and the plurality of electromagnets 51A are flat. Other structures are the same as the embodiment mentioned above.

Given the above, in the electromagnetic continuously variable transmission system, when the plurality of electromagnets are electrified, the plurality of pulley balls are magnetically attracted by the plurality of electromagnets, the pulley will not move outward due to the centrifugal force during revolution, so the pulley has a lower moment of inertia, and the engine revolves in a greater speed and has a more preferable acceleration capability.

While we have shown and described various embodiments in accordance with the present invention, it should be clear to those skilled in the art that further embodiments may be made without departing from the scope of the present invention.

What is claimed is:

1. An electromagnetic continuously variable transmission system, including:
a pulley, including a first disc and a second disc, a center of the first disc having an axial sleeve, one of two sides of the first disc on an axial direction having a plurality of grooves which extend radially, a plurality of pulley balls being respectively slidably received within respective ones of the plurality of grooves, the other of the two sides of the first disc having a first slope, the second disc being located by the side of the first disc having the plurality of grooves;
a driving shaft, disposed within the axial sleeve of the first disc and the second disc, the first disc being slidable relative to an axial direction of the driving shaft;
an electromagnetic assembly, disposed on the pulley, including a plurality of electromagnets, the plurality of electromagnets being spacingly arranged in a part of the plurality of grooves and near one end of the axial sleeve;
wherein when each of the plurality of electromagnets is electrified and generate magnetism, each of the plurality of electromagnets magnetically attracts one of the plurality of pulley balls corresponding thereto toward the axial sleeve.

2. The electromagnetic continuously variable transmission system of claim 1, wherein the electromagnetic assembly further includes a conducting disc, the conducting disc is electrically connected to the plurality of electromagnets, and the conducting disc is disposed on one side of the second disc remote from the first disc.

3. The electromagnetic continuously variable transmission system of claim 2, further including a control module, the control module including a switch and a power supply unit, and when the switch is turned on, the power supply unit supplies electricity to the conducting disc.

4. The electromagnetic continuously variable transmission system of claim 2, wherein a plurality of conductive brushes extends radially beyond the conducting disc.

5. The electromagnetic continuously variable transmission system of claim 2, wherein a plurality of conductive brushes extends axially beyond the conducting disc.

6. The electromagnetic continuously variable transmission system of claim 1, further including a third disc, the driving shaft being disposed into the third disc, the first disc being between the second disc and the third disc, one side of the third disc toward the first slope having a second slope, the first slope and the second slope configured for engagement of a transmission belt therebetween.

7. The electromagnetic continuously variable transmission system of claim 1, wherein a number of the plurality of electromagnets is half a number of the plurality of grooves.

8. The electromagnetic continuously variable transmission system of claim 1, wherein the plurality of electromagnets are disposed through the second disc and project into the part of the plurality of grooves.

9. The electromagnetic continuously variable transmission system of claim 8, wherein each of the plurality of electromagnets has a curved surface which is shaped in complementary to a circumference of one of the plurality of pulley balls.

10. The electromagnetic continuously variable transmission system of claim 1, wherein the plurality of electromagnets are disposed on an outer circumference of the axial sleeve, and the plurality of electromagnets are flat.
